(19) United States
(12) Patent Application Publication
(10) Pub. No.: US 2026/0099949 A1
(43) Pub. Date: Apr. 9, 2026

(54) ADAPTIVE IMAGE ENCODING AND DECODING FOR RESOLUTION-CONSTRAINED SYSTEMS

(71) Applicant: NVIDIA Corporation, Santa Clara, CA (US)

(72) Inventors: Amit KALE, Pune (IN); Bhushan RUPDE, Pune (IN); Kaustubh PURANDARE, San Jose, CA (US)

(73) Assignee: NVIDIA Corporation, Santa Clara, CA (US)

(21) Appl. No.: 18/907,865

(22) Filed: Oct. 7, 2024

(51) Int. Cl. G06T 9/00; G06T 5/20; G06V 10/25

(52) U.S. Cl. CPC G06T 9/00; G06T 5/20; G06V 10/25

(57) ABSTRACT

In various examples, systems and methods are disclosed relating to encoding and decoding high-resolution images on systems supporting limited resolutions. A system can identify an image to be encoded using an image encoding process. The system can extract a plurality of regions from the image and can generate a plurality of encoded regions by encoding each of the plurality of regions using the image encoding process. The system can generate a media package using the plurality of encoded regions and metadata corresponding to the plurality of regions.

### BACKGROUND

High-resolution image encoding involves compressing large amounts of pixel data into a smaller file size for transmission and storage. This compression process uses algorithms to reduce redundancy within the image data, thereby minimizing the overall file size without significantly compromising visual quality. However, encoding very high-resolution images can quickly exhaust processing power and memory resources of computing devices.

### SUMMARY

Embodiments of the present disclosure provide techniques for adaptively encoding high-resolution media (e.g., images/video) on platforms characterized with limited computing resources. Certain media systems, such as those employed in industrial inspection or medical imaging, generate media with resolutions reaching hundreds of megapixels. Encoding and decoding these high-resolution images for processing, while feasible on performant distributed computing systems equipped with dedicated hardware, proves impractical when utilizing conventional computing devices constrained by limited resources.

Conventional encoding and decoding operations for high-resolution media involve the simultaneous processing of the entire high-resolution image. However, conventional computing systems lack both contiguous available memory and sufficient processing resources to accommodate the storage and processing demands of an entire high-resolution image. This processing challenge is particularly pronounced on edge devices or computing systems lacking substantial video memory for image data manipulation. These inherent limitations render it infeasible to encode or decode high-resolution media on conventional computing systems.

The techniques described herein can be implemented to efficiently and adaptively encode and decode high-resolution media on computing systems with limited computational capacity. To achieve efficient encoding of media data, an input high-resolution image or frame from a high-resolution video can be segmented into a set of regions. Each region may encompass a region of interest (ROI), a tile, or any other portion of the image/video intended for encoding. Metadata indicating the relative location and size of each region can be generated, enabling the mapping of data from each region back to its original position and dimensions within the high-resolution image/video frame. Once the high-resolution media has been partitioned into regions, each region can be encoded using a suitable media encoding algorithm. The encoded regions are subsequently combined with the generated metadata to form a media package (e.g., an image/video file), which can then be stored or transmitted for further processing.

At least one aspect relates to one or more processors. The one or more processors can include one or more circuits. The one or more circuits can extract a plurality of regions from an image to be encoded using an image encoding process. The one or more circuits can generate a plurality of encoded regions by encoding each of the plurality of regions using the image encoding process. The one or more circuits can generate a media package using the plurality of encoded regions and metadata corresponding to the plurality of regions.

In some implementations, the one or more circuits can generate the metadata to include/indicate/track/record the respective location of each of the plurality of regions within the image. In some implementations, the one or more circuits can generate the media package by concatenating each of the plurality of encoded regions. In some implementations, the one or more circuits can generate a header for the media package to include the metadata corresponding to the plurality of regions. In some implementations, the metadata is provided as exchangeable image file format (EXIF) data in the header of the media package.

In some implementations, the media package comprises one of a Joint Photographic Experts Group (JPEG) file, a portable network graphics (PNG) file, a tagged image file format (TIFF) file, or a WEBP file. In some implementations, each region of the plurality of regions comprises a different size. In some implementations, the one or more circuits can encode a first region of the plurality of regions using a first set of encoding parameters. In some implementations, the one or more circuits can encode a second region of the plurality of regions using a second set of encoding parameters.

At least one aspect relates to a system. The system can include one or more processors. The system can extract at least a plurality of encoded regions from a media package. The system can generate a plurality of regions of an image by decoding the plurality of encoded regions. The system can generate the image using at least the plurality of regions.

In some implementations, the system can apply a filter to the image to remove an encoding artifact that may occur on the boundaries of the ROI, tile, etc. In some implementations, the system can parse a header of the media package to identify metadata corresponding to the plurality of encoded regions. In some implementations, the system can determine, based at least on metadata corresponding to the plurality of encoded regions, one or more offsets for the plurality of encoded regions in the media package. In some implementations, the media package comprises an image file, wherein each of the plurality of encoded regions is concatenated and stored as image data in the image file.

In some implementations, the system can decode a first encoded region of the plurality of encoded regions using a first set of decoding parameters. In some implementations, the system can decode a second encoded region of the plurality of encoded regions using a second set of decoding parameters. In some implementations, one or more of the first set of decoding parameters and the second set of decoding parameters are stored in the metadata.

At least one aspect is related to a method. The method can include obtaining, using one or more processors, a plurality of regions from an image to be encoded. The method can include applying, using the one or more processors, a plurality of levels of compression to the plurality of regions to generate a plurality of encoded regions. The method can include concatenating, using the one or more processors, the plurality of encoded regions to generate a media package.

In some implementations, the method can include generating, using the one or more processors, metadata corresponding to the plurality of regions, the metadata including the respective location of each of the plurality of regions within the image. In some implementations, the media package is generated using at least the metadata corresponding to the plurality of regions.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model (LLM), a system for performing generative AI operations using a small language model (SLM), a system for performing one or more conversational AI operations, a system for presenting at least one of virtual reality content, augmented reality content, or mixed reality content, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for adaptive image encoding and decoding for resolution-constrained systems are described in detail below with reference to the attached drawing figures, wherein:

FIG. 1 is a block diagram of an example system for encoding and decoding high-resolution images, in accordance with some embodiments of the present disclosure.

FIG. 2 shows an example data flow diagram showing an encoding process for high-resolution images, in accordance with some embodiments of the present disclosure;

FIG. 3 is an example diagram showing a decoding process for high-resolution images encoded according to the techniques described herein, in accordance with some embodiments of the present disclosure;

FIG. 4 is a flow diagram of an example method for encoding and decoding high-resolution images on systems supporting limited resolutions, in accordance with some embodiments of the present disclosure;

FIG. 5 is a block diagram of an example content streaming system suitable for use in implementing some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

This disclosure relates to systems and methods for adaptively encoding high-resolution media (e.g., images/video) on platforms having limited computing resources. Certain media systems, such as industrial inspection systems or medical imaging systems, produce media having resolutions numbering in the hundreds of megapixels. Encoding and decoding such images for processing, although possible on performant, distributed computing systems with specialized hardware, is impracticable to perform using conventional computing devices with limited resources.

Conventional encoding and decoding operations for high-resolution media involve processing the entirety of a high-resolution image at once. However, conventional computing systems lack contiguous available memory and processing resources to both store and process an entire high-resolution image. Such processing is particularly challenging on edge devices or computing systems that do not include large amounts of video memory for processing image data. These limitations make it impossible to encode or decode high-resolution media on conventional computing systems.

The system and methods described herein provide techniques to efficiently and adaptively encode and decode high-resolution media on computing systems with limited computing resources. To efficiently encode media data, an input high-resolution image or frame of a high-resolution video can be segmented into a set of regions. Each region may include a region of interest (ROI), a tile, or other portion of the image/video to be encoded. Metadata indicating a relative location and size of the region can be generated, such that data from each region can be later/subsequently mapped back to its original location and size in the high-resolution image/video frame using the metadata.

The regions extracted from the high-resolution media can each be the same size or may be different sizes. In one example, a high-resolution image can be sub-divided into four equal-size tile regions. In another example, the size of each region may be determined based on the content depicted via the pixels of the high-resolution image/video frame. Once the high-resolution media has been sub-divided into regions, each region can be encoded using a suitable media encoding algorithm, such as JPEG, PNG, or JPEG-2000, among others. The encoded regions can then be combined with the generated metadata into a media package (e.g., an image/video file), which can be stored or transmitted for further processing.

To decode the encoded media package, the metadata can be extracted from the package and used to enumerate the number, size, and binary offsets for each region of the original media data. Using a suitable decoding process, image data for each region can be decoded individually and subsequently combined to reconstruct the original high-resolution image. The metadata extracted from the media package can indicate a mapping of the size and location of each region to the high-resolution image. In some implementations, a filtering process can be performed to reduce potential artifacts between each region in the reconstructed high-resolution image specifically occurring on boundaries of the tile.

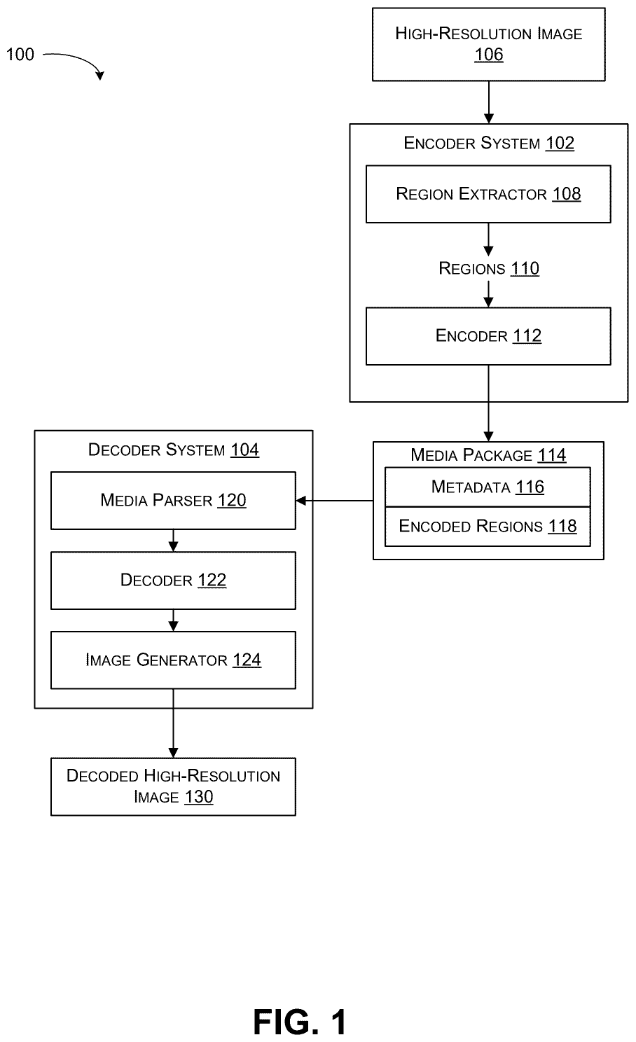

With reference to FIG. 1, FIG. 1 is an example computing environment including a system 100 for implementing encoding and decoding high-resolution images on systems supporting limited resolutions, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including an encoder system 102 that can receive a high-resolution image 106 and generates a media package 114, and a decoder system 104 that can receive the media package 114 and can generate a decoded high-resolution image 130. The encoder system 102 can implement the various techniques described herein to encode high-resolution images 106 by extracting one or more regions 110 from the high-resolution image 106 and encodes each region 110 individually. The encoder system 102 can receive the high-resolution image 106, for example, from one or more computer networks. In some implementations, the encoder system 102 can access the high-resolution image 106 from a data repository or storage system. The storage system may be an external server, distributed storage/computing environment (e.g., a cloud storage system), or any other type of storage device or system that is in communication with the encoder system 102 and/or the decoder system 104. In some implementations, the storage system may form a part of, or may otherwise be internal to, the encoder system 102 and/or the decoder system 104. In such implementations, the encoder system 102 can access the high-resolution image 106 from internal memory.

The encoder system 102 may access, retrieve, or otherwise receive the high-resolution image 106 in response to receiving a request to encode the high-resolution image 106 according to the techniques described herein. The request may be provided by a device external to and in communication with the encoder system 102 (e.g., a client device communicating via a network). In some implementations, the request may be provided in response to input at the encoder system 102, for example, by an operator of the encoder system 102. The request may specify the high-resolution image 106 to process or a location from which the high-resolution image 106 is to be retrieved by the encoder system 102.

The high-resolution image 106 can include any type of a digital image information that includes a large number of pixels. Examples of high-resolution images 106 may include images having greater than a threshold number of pixels, including but not limited to 50 megapixel images, 64 megapixel images, 100 megapixel images, 150 megapixel images, or 200 megapixel images, among others. The number of pixels (e.g., resolution) of the high-resolution image 106 may vary depending on the source of the high-resolution image. For example, industrial inspection systems may generate images with resolutions exceeding hundreds of megapixels such that they can effectively capture minute details on manufactured components or machine surfaces. The high-resolution image 106 may be an image generated from one or more medical imaging systems, such as those used for high-resolution computed tomography (CT) scans or magnetic resonance imaging (MRI), which may include similarly high resolutions to represent internal anatomical structures with precision. The high-resolution image 106 may be an image generated by other systems, such as surveillance cameras used in city infrastructure or building security, which capture detailed visual data for monitoring and safety purposes. These systems employ advanced imaging technologies to produce high-quality images and video feeds for real-time observation and post-event analysis. In addition, high-resolution imaging can be utilized in various fields, including satellite imagery for geographical mapping or environmental monitoring.

In some implementations, the high-resolution image 106 may represent a single frame extracted from a high-resolution video sequence. Such high-resolution videos may be provided from surveillance systems or entertainment/communication systems, which may transmit or otherwise process/access high-resolution video data. In such implementations, the encoder system 102 may process high-resolution image 106 data for each frame individually according to the techniques described herein. The high-resolution image 106 may be stored, provided, or otherwise accessed in any number of image formats, including but not limited to raw image data (e.g., bitmap (BMP) image), a portable network graphics (PNG) image, a tagged image file format (TIFF) image, or other lossless image formats.

To encode the high-resolution image 106, the encoder system 102 can execute a region extractor 108 to extract (e.g., determine, obtain, isolate, retrieve, identify, etc.) one or more regions 110 of the high-resolution image 106 to be individually encoded by an encoder 112. In one example, the region extractor 108 may extract the regions 110 from the high-resolution image 106, for example, by sub-dividing the high-resolution image 106 into tiles. In one example, the tiles can be equal in size and may form a grid structure across the entire high-resolution image 106. The number and dimensions of these regions 110 can be determined as a configurable parameter for the encoding process, which may be specified in the request to encode the high-resolution image 106 and/or in a configuration setting of the encoder system 102.

In some implementations, the region extractor 108 may extract regions 110 that are not all equal in size. For example, can region extractor 108 can extract the regions as non-uniform partitions of the high-resolution image 106, which may be identified based on configuration settings of the encoder system 102, based on the request to encode the high-resolution image 106, or based on the content of the high-resolution image 106, or other factors such as predefined templates, external input parameters, or real-time analysis of the image. These additional factors may include contextual information, user preferences, or specific algorithmic criteria that include how regions are segmented for extraction. In some implementations, the size and shape of each region 110 can be dynamically determined based on the content of the high-resolution image 106. The regions 110 extracted by the region extractor 108 may include continuous regions of pixels. In some implementations, the regions 110 can be square or rectangular regions of the high-resolution image 106. The regions 110 can be extracted such that no pixel is included in more than one region 110 and such that all regions 110 can be combined to re-assemble the high-resolution image 106.

In some implementations, the region extractor 108 can implement one or more image processing techniques, including but not limited to image classification machine-learning model(s), object/feature detection models, or image segmentation models to dynamically determine the size and shape of different regions 110 of the high-resolution image 106. For example, an object detection model can be used to identify objects or features of interest within the high-resolution image 106. The region extractor 108 can then extract regions 110 that encompass these detected objects or features, minimizing the splitting of any single object or feature across multiple regions 110. In some implementations, the high-resolution image 106 may include data (e.g., segmentations, bounding boxes, classifications, etc.) indicating objects/features of interest present in the high-resolution image 106.

In some implementations, the region extractor 108 may receive the dimensions/size of the regions 110 to be extracted from the high-resolution image 106 from one or more external computing systems. For example, the external computing system may be a system that performs downstream processing using the encoded high-resolution image. Based on the performance/quality or application-specific requirements of downstream processing, the external computing system may provide feedback indicating the size/dimensions of different regions 110, or updates to configuration settings to increase, decrease, or otherwise modify the number or dimensions of regions 110 to be extracted from the high-resolution image 106. In an example where the high-resolution image 106 is a frame of a video stream, processing of prior frames (e.g., decoding and using in downstream processing tasks) may provide feedback for subsequent frames in the video stream to be encoded by the encoder system 102.

Once extracted, the encoder system 102 can execute an encoder 112 to encode each of the regions 110 into a set of encoded regions 118. The encoder 112 can be executed to encode each of the regions 110 sequentially, or in some implementations, in parallel. To encode each region 110, the encoder 112 can execute any suitable image encoding algorithms. Non-limiting examples of such encoding algorithms include but are not limited to Joint Photographic Experts Group (JPEG) encoding, JPEG-2000 encoding, PNG encoding, Graphics Interchange Format (GIF) encoding, or WebP encoding, among others. Any suitable lossy or lossless encoding algorithm may be used to encode the regions 110 into a compressed format suitable for storage or transmission in a media package 114.

In some implementations, the encoder 112 may encode the regions 110 according to one or more quality parameters. These quality parameters may include a compression level or quality level that is to be applied to each region 110 during encoding. Using different quality or compression levels allows for optimized storage and transmission efficiency while preserving visual fidelity in regions 110 presenting the most relevant visual information. In one example, regions 110 including high-frequency details, such as edges, textures, or sharp transitions, may be encoded with higher quality settings (e.g., lower quantization parameter (QP) in JPEG encoding), resulting in less compression artifacts and better preservation of fine detail.

In another example, regions 110 exhibiting smoother content, such as uniform backgrounds or areas with gradual color changes, can be encoded with lower quality settings (e.g., higher QP). This approach allows for greater compression without significantly impacting the perceived visual quality of these regions. In some implementations, the encoder 112 can determine quality parameters for one or more regions 110 based on pre-defined rulesets, content-based analyses (e.g., edge detection, texture classification), or specified preferences (e.g., in the request to process the high resolution image 106, in configuration settings of the encoder system 102, etc.). Determining the encoding quality on a per-region 110 basis enables the encoder to minimize the size of the encoded high-resolution image (e.g., the media package 114) while preserving visual fidelity when decoded.

Once the regions 110 have been encoded, the encoder 112 can generate metadata 116 associated with each encoded region 118. This metadata 116 can include information such as the relative location of the corresponding region 110 within the original high-resolution image 106 (e.g., row and column coordinates), the size of the region 110 in pixels, or unique identifiers assigned to each region 110, among other metadata. The metadata 116 may also specify other relevant attributes, such as the encoding algorithm used to generate a particular encoded region 118, encoding/compression parameters employed, or any other information relating to the encoding process.

The generated metadata 116 is combined with the encoded regions 118 to form the media package 114. The encoder system 102 can generate media package 114, in one example, as an image file, by concatenating each of the encoded regions 118 as part of the image data of the image file and including the metadata 116 corresponding to the encoded regions 118 in one or more headers of the image file. In an example where JPEG encoding is used, the media package 114 may be generated as a JPEG file, with the metadata 116 stored as part of exchangeable image file format (EXIF) header data embedded in the JPEG file. Similar approaches may be used for different formats of the media package 114. In some implementations, the encoder system 102 can apply further compression to the media package 114, for example, to reduce its size for transmission via one or more networks. Non-limiting examples of compression include ZIP compression, GZIP compression, bzip2 compression, or LZMA compression, among others.

The media package 114 may include an identifier of the high-resolution image 106 from which the media package 114 was generate. In some implementations, the media package 114 may be stored and/provided to other downstream processing systems or processes. In this example, the media package 114 is shown as being provided to a decoder system 104. In some implementations, the media package 114 may be stored in one or more storage repositories and may be subsequently retrieved from the repositories for processing by the decoder system 104.

The decoder system 104 may be any type of computing system that decodes the media package 114 to generate a decoded high-resolution image 130. To generate the decoded high-resolution image 130, the decoder system 104 can execute a media parser 120. The media parser 120 can include hardware, software, or combinations of hardware and software. The media parser 120 can access a media package 114 generated from a high-resolution image 106 and parse the metadata 116 contained therein. Parsing the metadata 116 may include decompressing the media package 114, identifying header information stored in the media package 114, and parsing the header information to extract the metadata 116.

As described herein, the metadata 116 can include relative locations, dimensions, identifiers, and/or other properties of the encoded regions 118. Using the metadata 116, the media parser 120 can parse the image data of the media package 114 to extract each of the encoded regions 118 stored therein. For example, in some implementations, the media parser 120 can use the location data, dimension data, or size data to identify offsets within the media package 114 at which each of the encoded regions 118 are stored. Binary data representing each encoded region 118 can then be extracted using this offset information. In some implementations, the media parser 120 can parse all encoded regions 118 from the media package 114 prior to the encoded regions 118 being decoded. In some implementations, the media parser 120 can sequentially provide one or more encoded regions 118 as input to the decoder 122, to sequentially decode each of the encoded regions 118 prior to parsing the next encoded region(s) 118 in the media package 114.

Encoded regions 118 parsed by the media parser 120 can be provided as input to the decoder 122 for decoding. The decoder 122 can include hardware, software, or combinations of hardware and software. The decoder 122 can decode each encoded region 118 by reversing the operations applied to generate the encoded regions 118. In some implementations, the decoder 122 can access the metadata 116 of the media package 114 to identify the encoding parameters used to encode the corresponding encoded region 118. The encoded region 118 can be decoded using any suitable decoding process to reconstruct the pixel data of the encoded region 118, resulting in an output decoded region of pixel data. The decoder 122 can repeat this process for each encoded region 118 to generate a set of decoded regions that can be used to generate the decoded high-resolution image 130.

To generate the decoded high-resolution image 130, a media generator 124 can access the metadata 116 of the media package 114 to identify or otherwise determine the location of each decoded region within the original high-resolution image 106 used to generate the media package 114. For example, the metadata 116 may specify the row and column coordinates, size, or other identifiers for each encoded region 118 in relation to its position in the original high-resolution image 106. In some implementations, the identifier of each encoded region 118 may encode its relative location within the original high-resolution image 106. Once the locations of each region are determined, the media generator 124 can use the decoded regions to generate the decoded high-resolution image 130.

To do so, the media generator 124 can assemble the decoded regions into their correct positions within the decoded high-resolution image 130, which may be stored in one or more regions of memory in the decoder system 104. The media generator 124 may perform a process of mapping each decoded region to its corresponding location in the original high-resolution image 106 based on the location/size information derived from the metadata 116. The decoded high-resolution image 130 can include the pixel data of all decoded regions mapped to their corresponding locations, such that the decoded high-resolution image 130 resembles the high-resolution image 106.

In some implementations, generating the decoded high-resolution image 130 may result in one or more artifacts at the boundary between decoded regions used to generate the decoded high-resolution image 130. These artifacts can manifest as visible discontinuities, color banding, or blurring along the edges where different encoded regions are combined. To address any artifacts, the media generator 124 can apply one or more filtering operations such as tiling filters or deblocking filters at the portions of the decoded high-resolution image corresponding to the edges of the decoded regions. Applying filtering operations can smooth the transitions between adjacent decoded regions and can minimize visual discontinuities.

Tiling filters applied by the media generator 124 can include smoothing or blending techniques applied to pixel values proximate to the boundaries of two or more decoded regions, which can reduce visible block edges. Deblocking filters can be used to address various types of artifacts that may appear when generating the decoded high-resolution image 130, including quantization errors introduced during encoding. In some implementations, the media generator 124 can execute edge detection algorithms to identify sharp transitions between decoded regions and subsequently applying localized filtering operations to refine boundaries that are detected to include discontinuities.

The decoded high-resolution image 130 generated by the decoder system 104 may be stored in memory of the decoder system or provided to one or more computing systems or processes for further processing. For example, the decoder system 104 may be implemented as part of a computing system that processes image data using one or more machine-learning techniques or other image processing techniques. In such implementations, the decoded high-resolution image 130 can be provided as input to one or more machine-learning models or image processing algorithms. In some implementations, the high-resolution image can be rendered or displayed via one or more display devices.

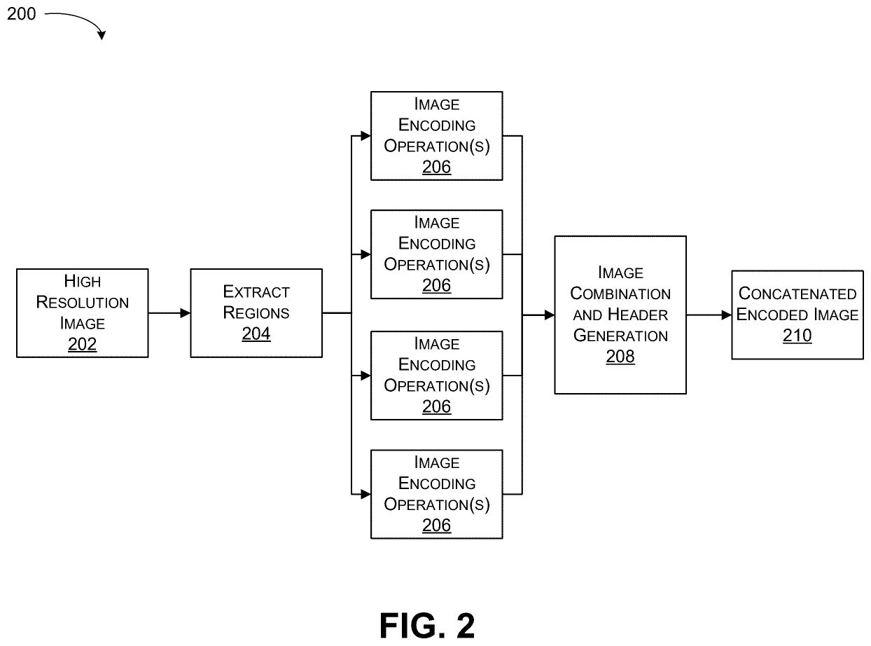

Referring to FIG. 2 in the context of the components described in connection with FIG. 1, illustrated is an example data flow diagram 200 showing an encoding process for high-resolution images, in accordance with some embodiments of the present disclosure. As shown, the encoding process can be used to encode a high-resolution image 202 (e.g., a high-resolution image 106). A region extraction process 204 can be applied to the high-resolution image to extract one or more regions (e.g., regions 110) of pixel data that can be separately encoded using the image encoding operations 206.

As shown, image encoding operations can be used to encode each region separately. Although shown as being performed in parallel, it should be understood that, in some implementations at least a portion of the encoding operations may be performed sequentially (e.g., one or more regions at a time). Encoding the regions can include performing the operations of the encoder 112 of FIG. 1, to generate corresponding encoded regions (e.g., encoded regions 118) for the regions generated using the region extraction process 204. A concatenated encoded image 210 (e.g., a media package 114) can then be generated using the image combination and header generation process 208.

The image combination and header generation process 208 can generate metadata and can store the metadata as header information in the concatenated encoded image 210. As described herein, the metadata may indicate the size, location, dimensions, and/or identifiers of each encoded region generated from the high-resolution image 202. The concatenated encoded image can be generated by the image combination and header generation process 208 by concatenating each encoded region together into a single file or data structure. In some implementations, the image combination and header generation process 208 can compress the concatenated encoded image using a suitable encoding algorithm.

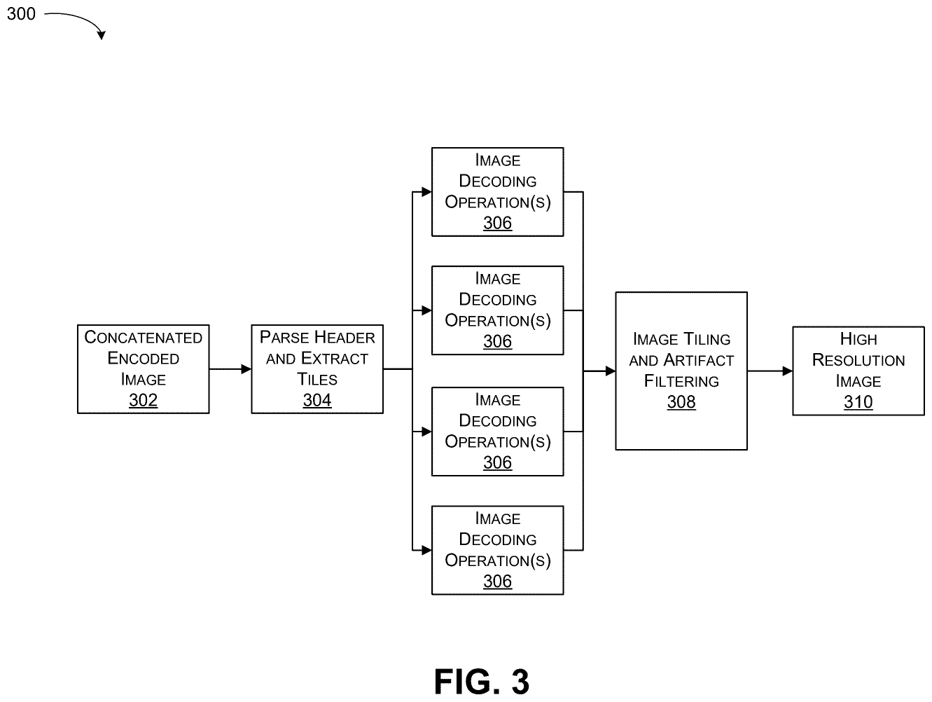

Referring to FIG. 3 in the context of the components described in connection with FIGS. 1 and 2, depicted is an example diagram 300 showing a decoding process for high-resolution images encoded according to the techniques described herein, in accordance with some embodiments of the present disclosure. The decoding process may be used to decode a concatenated encoded image 302 (e.g., the concatenated encoded image 210, the media package 114, etc.). To decode the concatenated encoded image 302, a header parsing and tile extraction process 304 can be executed, which can identify each of the encoded tiles (e.g., encoded regions 118) within the concatenated encoded image 302 using the metadata included in the concatenated encoded image 302. As described herein, the metadata may specify or provide information that can be used to derive the locations of each encoded tile (e.g., binary locations, binary offsets, etc.) within the concatenated encoded image 302.

The encoded tiles/regions extracted from the concatenated encoded image 302 can be decoded using corresponding image decoding operations 306, as shown. Although shown as being performed in parallel, it should be understood that, in some implementations, at least a portion of the decoding operations may be performed sequentially (e.g., one or more regions at a time). Decoding the regions can include performing the inverse of the operations of the encoder 112 of FIG. 1, to generate corresponding decoded regions which can be used to reassemble a high-resolution image 310.

The decoded regions are provided as input to an image tiling and artifact filtering process 308, which is used to assemble each of the decoded regions/tiles into the high-resolution image 310 according to the metadata. In some implementations, filtering can be performed to reduce artifacts that may occur from separately encoding each region to generate the concatenated encoded image 302. The high-resolution image 310, once generated, can be provided to one or more computing systems for further processing.

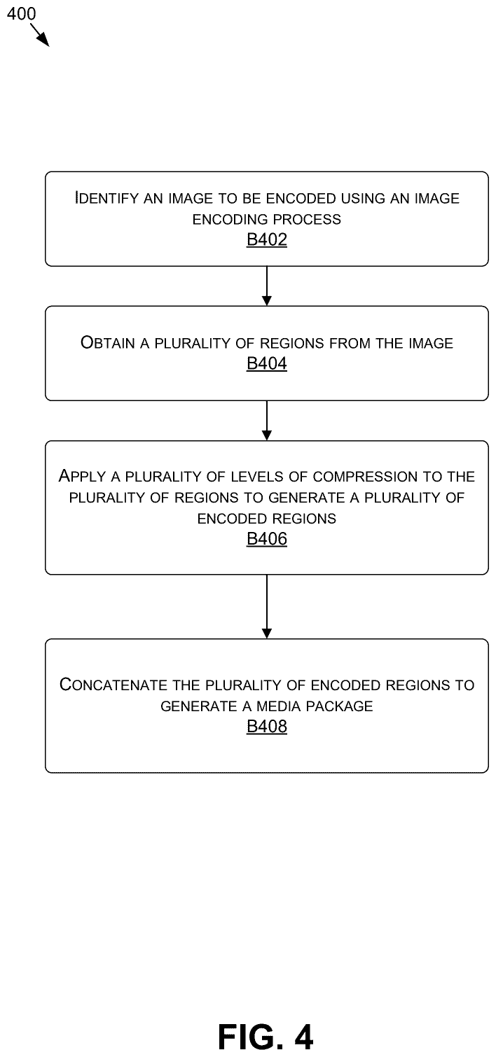

FIG. 4 is a flow diagram showing a method 400 for implementing encoding and decoding high-resolution images on systems supporting limited resolutions, in accordance with some embodiments of the present disclosure. Various operations of the method 400 can be implemented by the same or different devices or entities at various points in time. For example, one or more first devices may implement operations relating to encoding high-resolution images to generate media packages, and one or more second devices may implement operations relating to decoding media packages to reconstruct encoded high-resolution images.

Each block of method 400, described herein, includes a computing process that may be performed using any combination of hardware, firmware, and/or software. For instance, various functions may be carried out by a processor executing instructions stored in memory. The method 400 may also be embodied as computer-usable instructions stored on computer storage media. The method 400 may be provided by a standalone application, a service or hosted service (standalone or in combination with another hosted service), or a plug-in to another product, to name a few. In addition, method 400 is described, by way of example, with respect to the systems of FIGS. 1 and 2. However, this method 400 may additionally or alternatively be executed by any one system, or any combination of systems, including, but not limited to, those described herein.

The method 400, at block B402, includes identifying an image to be encoded (e.g., a high-resolution image 106) using an image encoding process. Identifying the image may include retrieving the image from one or more data repositories, receiving the image from an external computing system (e.g., in a request to encode the image), or receiving the image via another application or process (e.g., via inter-process communication). In some implementations, the resolution of the image can be determined based on header information or content data of the image. Furthering this example, if the image resolution exceeds a threshold value (e.g., exceeding processing capabilities of the computing system to encode the image), the method can proceed to block B404. In some implementations, the method can proceed to block B404 regardless of whether the resolution of the image exceeds the threshold.

The method 400, at block B404, includes obtaining a plurality of regions (e.g., regions 110) from the image. The regions can be extracted to sub-divide the image into multiple tiles, which can be individually encoded according to the techniques described herein. Extracting the regions may include performing any of the operations described in connection with the region extractor 108 of FIG. 1. In some implementations, each of the regions can be the same size. In some implementations, the number of regions may be dependent on the resolution of the image. In some implementations, the regions may be of different sizes. The parameters of the regions (e.g., size, location, number, etc.) may be provided as configuration settings for the encoding process. Such parameters may be stored in a configuration file, provided in a request to encode the image, or provided via operator input. Once the parameters of the regions have been determined, the regions can be extracted by extracting pixel data for each region from the image.

The method 400, at block B406, includes applying a plurality of levels of compression to generate a plurality of encoded regions (e.g., encoded regions 118). The levels of compression can be applied by encoding each of the plurality of regions using the image encoding process. The regions of pixel data extracted at step B406 can be encoded using any suitable encoding process, including but not limited to JPEG encoding, JPEG-2000 encoding, PNG encoding, TIFF encoding, GIF encoding, or WEBP encoding, among others. In some implementations, encoding parameters for each region can be determined based on the content of the image. Regions having a higher level of detail (e.g., larger number of images, objects/features of interest, etc.) can be encoded using a higher quality parameter than regions having relatively lower levels of detail (e.g., smoother background, minimal edges/transitions between colors or features, etc.). In some implementations, one or more regions can be encoded in parallel. In some implementations, one or more regions can be encoded sequentially. Encoding the regions can include performing any of the operations of the encoder 112 of FIG. 1.

The method 400, at block B408, includes concatenating the plurality of encoded regions to generate a media package. The media package can be generated to include metadata (e.g., metadata 116) corresponding to the plurality of regions. The media package can be generated by concatenating each of the encoded regions and storing the concatenated regions as part of image data in the media package. In one example, the media package can be an image file (e.g., a JPEG file, a JPEG-2000 file, a TIFF file, a PNG file, a WebP file, etc.). The media package can include metadata indicating the respective location of each of the regions extracted from the image, as well as other parameters of each region (e.g., size, dimensions, identifier(s), etc.). The metadata can be stored at least in part in the header of the media package (e.g., EXIF data of a JPEG file, other header fields, etc.). The metadata can specify the encoding parameters used to encode each region, in some implementations. Once generated, the media package can be provided or stored for further processing by a computing system that decodes the media package (e.g., the decoder system 104, etc.).

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models - such as one or more large language models (LLMs) and/or one or more small language models (SLMs), a system for performing one or more conversational AI operations, a system for presenting at least one of virtual reality content, augmented reality content, or mixed reality content, systems for performing light transport simulation, systems for performing collaborative content creation for 3D assets, systems implemented at least partially using cloud computing resources, and/or other types of systems.

### EXAMPLE CONTENT STREAMING SYSTEM

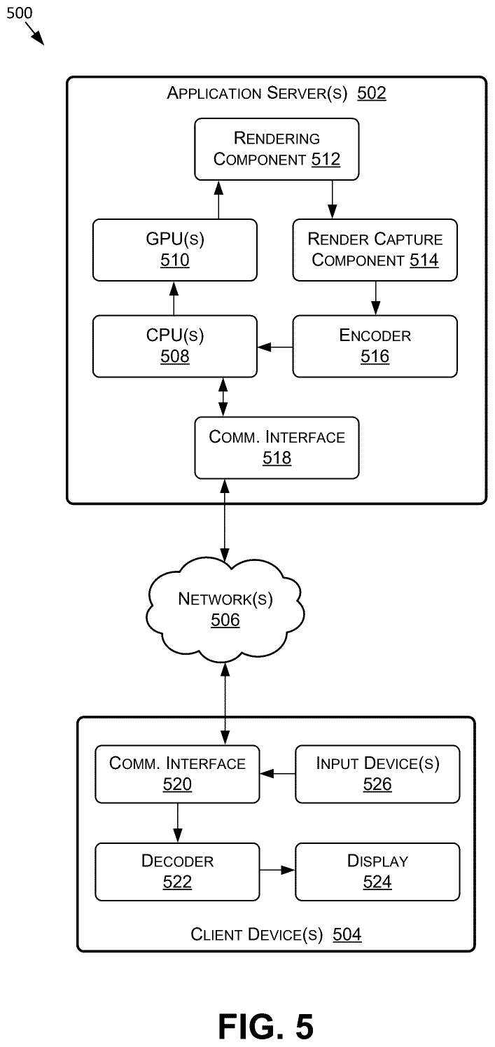

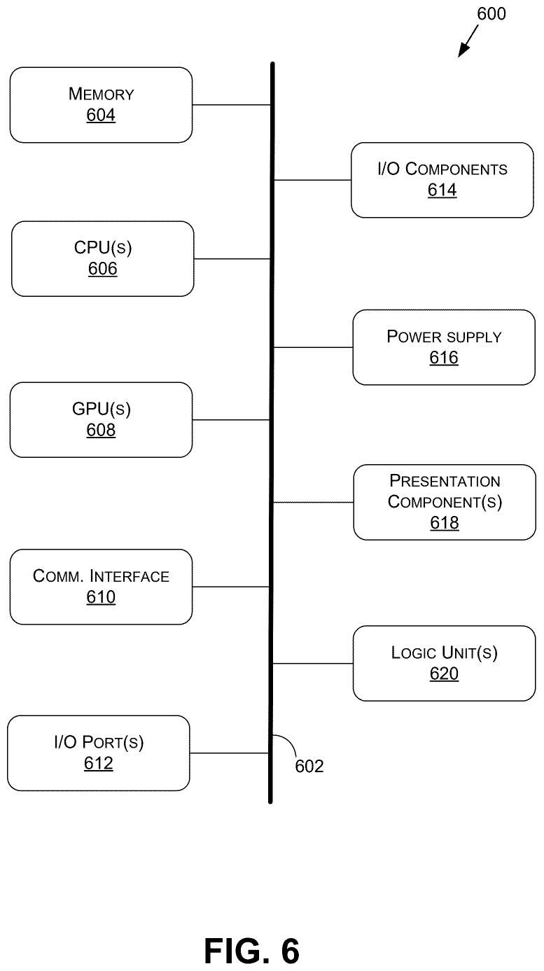

Now referring to FIG. 5, is an example system diagram for a content streaming system 500, in accordance with some embodiments of the present disclosure. FIG. 5 includes application server(s) 502 (which may include similar components, features, and/or functionality to the example computing device 600 of FIG. 6), client device(s) 504 (which may include similar components, features, and/or functionality to the example computing device 600 of FIG. 6), and network(s) 506 (which may be similar to the network(s) described herein). In some embodiments of the present disclosure, the system 500 may be implemented to conceal errors in video streams by selectively applying error concealment functions selected based on the locations and severity of corrupted/missing data. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 500 can be implemented to receive input indicating one or more features of output to be generated using a neural network model, provide the input to the model to cause the model to generate the output, and use the output for various operations including display or simulation operations.

In the system 500, for an application session, the client device(s) 504 may only receive input data in response to inputs to the input device(s) 526, transmit the input data to the application server(s) 502, receive encoded display data from the application server(s) 502, and display the display data on the display 524. As such, the more computationally intense computing and processing is offloaded to the application server(s) 502 (e.g., rendering—in particular ray or path tracing—for graphical output of the application session is executed by the GPU(s) of the application server(s) 502). In other words, the application session is streamed to the client device(s) 504 from the application server(s) 502, thereby reducing the requirements of the client device(s) 504 for graphics processing and rendering.

For example, with respect to an instantiation of an application session, a client device 504 may be displaying a frame of the application session on the display 524 based at least on receiving the display data from the application server(s) 502. The client device 504 may receive an input to one of the input device(s) 526 and generate input data in response. The client device 504 may transmit the input data to the application server(s) 502 via the communication interface 520 and over the network(s) 506 (e.g., the Internet), and the application server(s) 502 may receive the input data via the communication interface 518. The CPU(s) 508 may receive the input data, process the input data, and transmit data to the GPU(s) 510 that causes the GPU(s) 510 to generate a rendering of the application session. For example, the input data may be representative of a movement of a character of the user in a game session of a game application, firing a weapon, reloading, passing a ball, turning on a vehicle, etc. The rendering component 512 may render the application session (e.g., representative of the result of the input data) and the render capture component 514 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 502. In some embodiments, one or more virtual machines (VMs)—e.g., including one or more virtual components, such as vGPUs, vCPUs, etc.—may be used by the application server(s) 502 to support the application sessions. The encoder 516 may then encode the display data to generate encoded display data and the encoded display data may be transmitted to the client device 504 over the network(s) 506 via the communication interface 518. The client device 504 may receive the encoded display data via the communication interface 520 and the decoder 522 may decode the encoded display data to generate the display data. The client device 504 may then display the display data via the display 524.

### EXAMPLE COMPUTING DEVICE

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may be arranged in various topologies, including but not limited to bus, star, ring, mesh, tree, or hybrid topologies. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU 608 may include its own memory or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, including wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608. In some embodiments, a plurality of computing devices 600 or components thereof, which may be similar or different to one another in various respects, can be communicatively coupled to transmit and receive data for performing various operations described herein, such as to facilitate latency reduction.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### EXAMPLE DATA CENTER

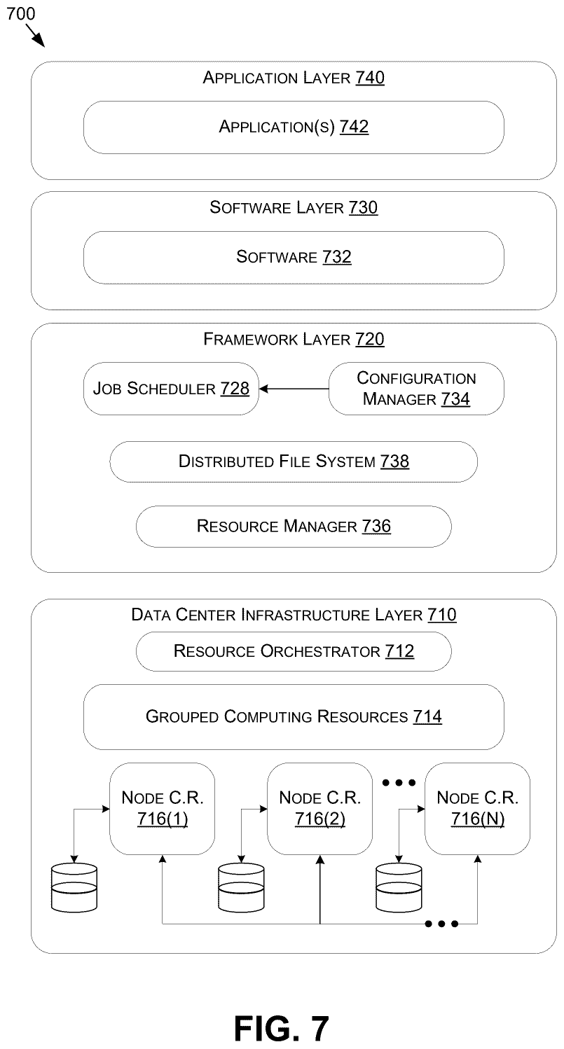

FIG. 7 illustrates an example data center 700 that may be used in at least one embodiments of the present disclosure, such as to implement the system 100, the operations described in connection with FIG. 2, or in one or more examples of the data center 700. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine-learning application, including training or inferencing software, machine-learning framework software (e.g., PyTorch, TensorFlow, Caffe, etc.), and/or other machine-learning applications used in conjunction with one or more embodiments.

In at least one embodiment, any of configuration manager 734, resource manager 736, and resource orchestrator 712 may implement any number and type of self-modifying actions based at least on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software, or other resources to update/train one or more machine-learning models or predict or infer information using one or more machine-learning models according to one or more embodiments described herein. For example, a machine-learning model(s) may be updated/trained by calculating weight parameters according to a neural network architecture using software and/or computing resources described above with respect to the data center 700. In at least one embodiment, trained or deployed machine-learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment - and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
extract a plurality of regions from an image to be encoded using an image encoding process;
generate a plurality of encoded regions by encoding each of the plurality of regions using the image encoding process; and
generate a media package using the plurality of encoded regions and metadata corresponding to the plurality of regions.

2. The one or more processors of claim 1, wherein the one or more circuits are to:
generate the metadata to include the respective location of each of the plurality of regions within the image.

3. The one or more processors of claim 1, wherein the one or more circuits are to:
generate the media package by concatenating each of the plurality of encoded regions.

4. The one or more processors of claim 1, wherein the one or more circuits are to:
generate a header for the media package to include the metadata corresponding to the plurality of regions.

5. The one or more processors of claim 4, wherein the metadata is provided as exchangeable image file format (EXIF) data in the header of the media package.

6. The one or more processors of claim 1, wherein the media package comprises one of a Joint Photographic Experts Group (JPEG) file, a portable network graphics (PNG) file, a tagged image file format (TIFF) file, or a WEBP file.

7. The one or more processors of claim 1, wherein each region of the plurality of regions comprises a different size.

8. The one or more processors of claim 1, wherein the one or more circuits are to:
encode a first region of the plurality of regions using a first set of encoding parameters;
and encode a second region of the plurality of regions using a second set of encoding parameters.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing one or more conversational AI operations;
a system for presenting at least one of virtual reality content, augmented reality content,
or mixed reality content;
a system for generating synthetic data;
a system incorporating one or more virtual machines (VMs);
a system implemented at least partially in a data center; or
a system implemented at least partially using cloud computing resources.

10. A system, comprising:
one or more processors to:
extract at least a plurality of encoded regions from a media package;
generate a plurality of regions of an image by decoding the plurality of encoded regions; and
generate the image using at least the plurality of regions.

11. The system of claim 10, wherein the one or more processors are to:
apply a filter to the image to remove an encoding artifact.

12. The system of claim 10, wherein the one or more processors are to:
parse a header of the media package to identify metadata corresponding to the plurality of encoded regions.

13. The system of claim 10, wherein the one or more processors are to:
determine, based on metadata corresponding to the plurality of encoded regions, one or more offsets for the plurality of encoded regions in the media package.

14. The system of claim 10, wherein the media package comprises an image file, wherein each of the plurality of encoded regions is concatenated and stored as image data in the image file.

15. The system of claim 10, wherein the one or more processors are to:
decode a first encoded region of the plurality of encoded regions using a first set of decoding parameters; and
decode a second encoded region of the plurality of encoded regions using a second set of decoding parameters.

16. The system of claim 15, wherein one or more of the first set of decoding parameters and the second set of decoding parameters are stored in the metadata.

17. The system of claim 10, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing one or more conversational AI operations;
a system for presenting at least one of virtual reality content, augmented reality content,
or mixed reality content;
a system for generating synthetic data;
a system incorporating one or more virtual machines (VMs);
a system implemented at least partially in a data center; or
a system implemented at least partially using cloud computing resources.

18. A method, comprising:
obtaining, using one or more processors, a plurality of regions from an image to be encoded;
applying, using the one or more processors, a plurality of levels of compression to the plurality of regions to generate a plurality of encoded regions; and
concatenating, using the one or more processors, the plurality of encoded regions to generate a media package.

19. The method of claim 18, further comprising
generating, using the one or more processors, metadata corresponding to the plurality of regions, the metadata including the respective location of each of the plurality of regions within the image.

20. The method of claim 19, wherein the media package is generated using at least the metadata corresponding to the plurality of regions.
